(19) United States
(12) Patent Application Publication
(10) Pub. No.: US 2026/0152098 A1
(43) Pub. Date: Jun. 4, 2026

(54) SHOULDER STRAP WIDTH ADJUSTMENT MECHANISM AND CHILD SAFETY SEAT

(71) Applicant: BAMBINO PREZIOSO SWITZERLAND AG, Steinhausen (CH)

(72) Inventor: Daliang Zhang, Steinhausen (CH)

(21) Appl. No.: 19/460,635

(22) Filed: Jan. 27, 2026

Related U.S. Application Data
(63) Continuation of application No. 18/250,132, now Pat. No. 12,559,001.

(30) Foreign Application Priority Data
Oct. 22, 2020 (CN) 202011135896.6

(51) Int. Cl. B60N 2/28; B60R 22/18

(52) U.S. Cl. CPC B60N 2/2812; B60N 2/2824; B60N 2/2827; B60N 2/2851; B60R 2022/1831

(57) ABSTRACT

The disclosure provides a shoulder strap width adjustment mechanism comprising: a rail device, arranged on a seat backrest, including a first rail and a second rail arranged on both sides of the seat backrest and extending substantially in a longitudinal direction, and a lateral distance between the first rail and the second rail gradually changes in the longitudinal direction; and two shoulder strap fixing members, connected to a seat headrest and positioned between the seat headrest and the seat backrest, and being slidable respectively along the first rail and the second rail of the rail device. In the disclosure, the shoulder strap width can be adjusted synchronously during the process of adjusting the height of the headrest, so as to meet the requirements of children of different heights and different body types.

### CROSS-REFERENCE TO RELATED APPLICATIONS

This application is a continuation of U.S. Ser. No. 18/250,132, filed Apr. 21, 2023, which is a National Stage application of PCT/IB2021/059704, filed Oct. 21, 2021, which claims the benefit of Chinese Application No. 202011135896.6, filed Oct. 22, 2020, all of which are incorporated by reference in their entirety herein.

### TECHNICAL FIELD

The disclosure relates to a shoulder strap width adjustment mechanism, and particularly to a child safety seat for a vehicle, the child safety seat includes a shoulder strap width adjustment mechanism.

### BACKGROUND

Child safety seat is a device specially designed for children of different weights or different ages. A child would be restrained in the child safety seat during travelling, in case of a car collision or sudden deceleration, the impact on the child is reduced and the child's body movement is restricted, thereby reducing their injuries, and effectively improving the safety of the seated child.

At present, most of the child safety seats in the market have the function of adjusting the height of the headrest. For example, in a patent document CN211641926U, a headrest height adjustment mechanism is proposed, which includes: a backrest with a plurality of locking slots; a headrest assembly movably arranged on the backrest; and a locking bar arranged on the headrest assembly, the locking bar is movably arranged in the locking slots, and the locking bar is locked into different locking slots to adjust a height of the headrest assembly in respect to the backrest; an adjustment member arranged on the headrest assembly for the locking bar; and an elastic member arranged between the adjustment member and the headrest assembly.

For example, another patent document CN210101399U also discloses a headrest height adjustment device, which includes a headrest and a seat back, and also includes a pulling member, an adjustment member and a resetting member. One end of the pulling member is a pulling end, and the other end has a first inclined surface. The adjustment member has a second inclined surface and a first locating part. One end of the adjustment member away from the second inclined surface is rotatably connected to the headrest. A resetting member is connected between the adjustment member and the headrest. The second inclined surface abuts and cooperates with the first inclined surface. The seat back is provided with several second locating parts along a height direction, and the adjustment member has a fixed position. When the adjustment member is in the fixed position, the first locating part and the second locating part are snap-fitted, and the headrest and the seat back are fixed in respect to each other.

### SUMMARY

An object of the disclosure is to provide a shoulder strap width adjustment mechanism and a child safety seat, wherein during the process of adjusting the height of the headrest, the shoulder strap width can be adjusted synchronously, so as to meet the requirements of children of different heights and different body types.

The disclosure provides a shoulder strap width adjustment mechanism comprising: a rail device, arranged on a seat backrest, including a first rail and a second rail arranged on both sides of the seat backrest and extending substantially in a longitudinal direction, and a lateral distance between the first rail and the second rail gradually changes in the longitudinal direction; and two shoulder strap fixing members, connected to a seat headrest and positioned between the seat headrest and the seat backrest, and being slidable respectively along the first rail and the second rail of the rail device.

The disclosure further provides a child safety seat for a vehicle. The child safety seat comprises: a base for connecting to a seat of the vehicle; a seat shell including a seat backrest and a seat bottom, the seat bottom is connected to the base, and the seat backrest is provided laterally with two shoulder strap holes through which the shoulder strap passes; a seat headrest being longitudinally and slidably connected to an upper part of the seat backrest for accommodating a child's head; and a shoulder strap width adjustment mechanism amounted on the seat backrest, for causing a lateral distance between the shoulder strap holes to change as the seat headrest slides on the seat backrest.

### BRIEF DESCRIPTION OF THE DRAWINGS

Those skilled in the art will understand, the drawings are mainly used for illustrative purposes and are not intended to limit the scope of the subject matter of the disclosure described herein. The drawings are not necessarily drawn to scale. In some cases, various aspects of the subject matter of the disclosure herein may be exaggerated or enlarged in the drawings to facilitate understanding of different features. In the drawings, the same reference numerals generally refer to the same features (e.g., functionally similar and/or structurally similar elements).

FIG. 1 is a schematic view of a child safety seat according to the disclosure;

FIGS. 2 and 3 respectively show different shoulder strap widths when a headrest of a child safety seat is at different heights;

FIG. 4 is a partial schematic view of a child safety seat according to the disclosure;

FIGS. 5 and 6 are respectively different structural schematic views of a shoulder strap width adjustment mechanism according to the disclosure; and

FIG. 7 is a schematic view of a shoulder strap fixing member according to the disclosure.

### DETAILED DESCRIPTION

The drawings and exemplary embodiments described below are not meant to limit the scope of these embodiments to a single embodiment. The embodiments can be realized by replacing part or all of the described or illustrated elements. In addition, in case that certain elements of the disclosed exemplary embodiment may be partially or wholly implemented using known components, in some cases, only the parts of such known components necessary for understanding this embodiment are described, and detailed descriptions of other parts of these known components are omitted so as not to obscure this embodiment.

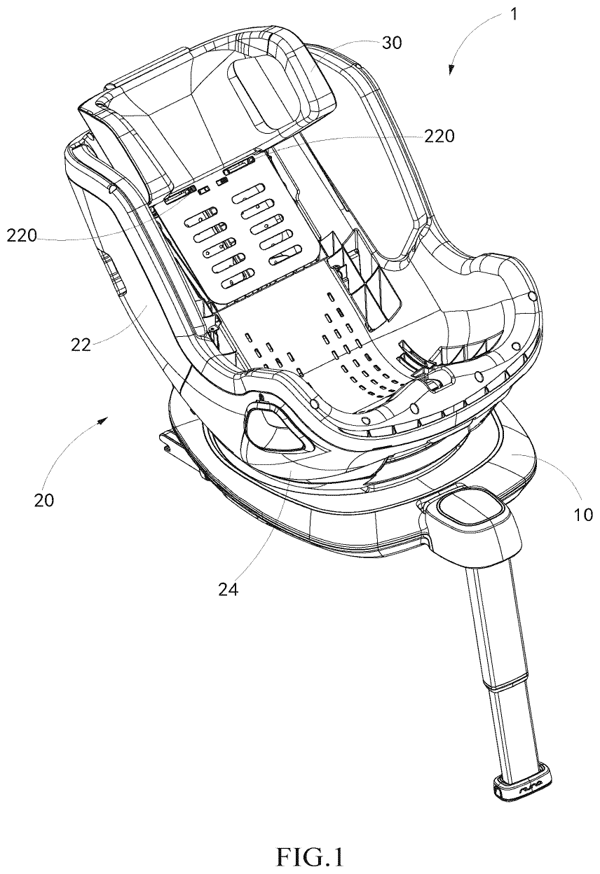

As shown in FIG. 1 which is a schematic view of a child safety seat 1 according to the disclosure. The child safety seat 1 mainly includes a base 10, a seat shell 20, and a seat headrest 30. The base 10, for example, is connected and fixed to a car's seat, so as to fix the child safety seat 1. The seat shell 20 constitutes a main structure of the child safety seat 1, and includes a seat backrest 22 and a seat bottom 24. The seat backrest 22 and the seat bottom 24 together constitute a seating space for a child. The headrest 30 is connected to the seat backrest 22, such that the child using the child safety seat 1 rests his head on the headrest 30 to increase comfortability. Moreover, the headrest 30 is slidable longitudinally along the seat backrest 22, so as to adjust a longitudinal distance between the headrest 30 and the seat bottom 24, which may meet the requirements of children of different ages and different sizes, and increase their comfortability when seating in the child safety seat 1. In addition, in the child safety seat 1 of the embodiment, two shoulder strap holes 220 are further arranged on the left and right sides along the transverse direction of the seat backrest 22, and a safety belt of the child safety seat passes through the two shoulder strap holes 220, so as to restrain the child in the child safety seat 1. Preferably, the two shoulder strap holes 220 are symmetrically distributed in respect to a longitudinal center line of the seat backrest 22.

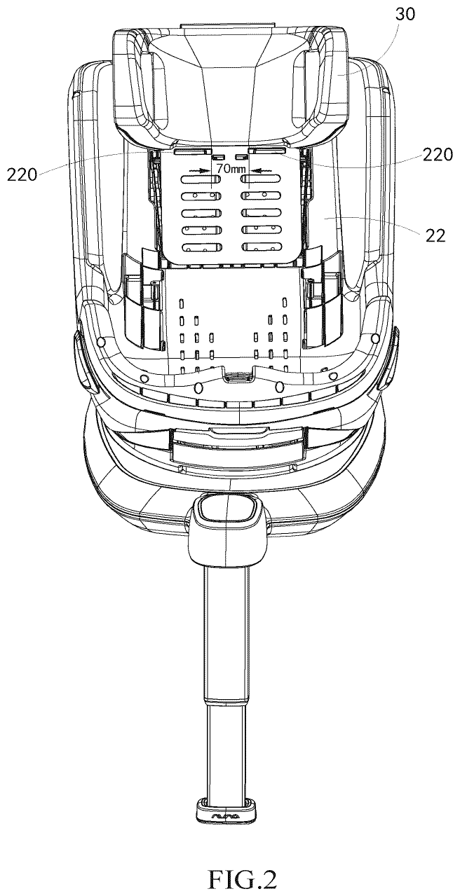

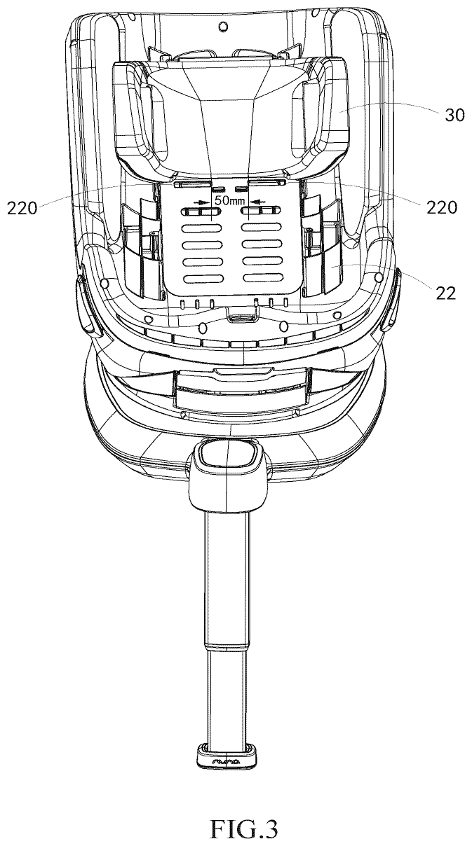

The child safety seat 1 of the disclosure also includes a shoulder strap width adjustment mechanism 40, in the process that the headrest 30 slides up and down along the seat backrest 22 in the longitudinal direction, a lateral distance between the shoulder strap holes 220 can be changed accordingly. For example, as shown in FIGS. 2 and 3 of the disclosure, when the headrest 30 is at an upper position in respect to the seat backrest 22 (shown in FIG. 2), the lateral distance between the shoulder strap holes 220 is, for example, 70 mm, and in FIG. 3, when the headrest 30 slides downward along the longitudinal direction of the seat backrest 22 to shorten a distance between the headrest 30 and the seat bottom 24, the lateral distance between the two shoulder strap holes 220 will be changed to, for example, 50 mm. In this way, for children of different ages and different body types, when the height of the headrest 30 is adjusted, the width of the shoulder strap width is also adjusted accordingly, thereby increasing the comfortability and safety in seating.

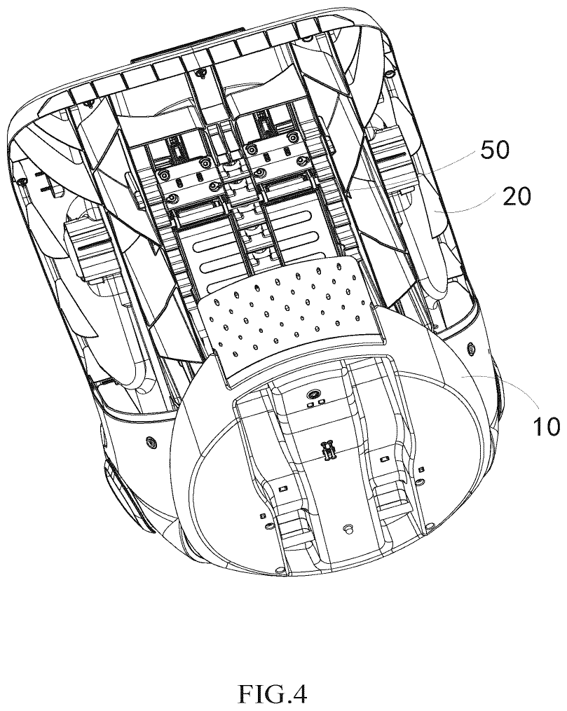

The child safety seat 1 of the disclosure also includes a clamping bar 50. As shown in FIG. 4, the clamping bar 50 is used to locate the headrest 30 to the seat shell 20, i.e., when the headrest 30 slide to a proper position in the longitudinal direction, the headrest 30 is fixed on the seat shell 20 by the clamping bar 50.

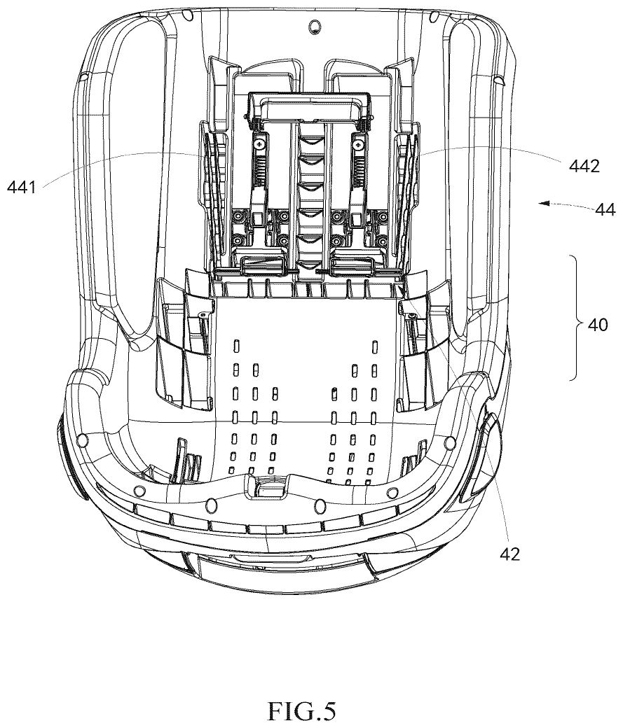

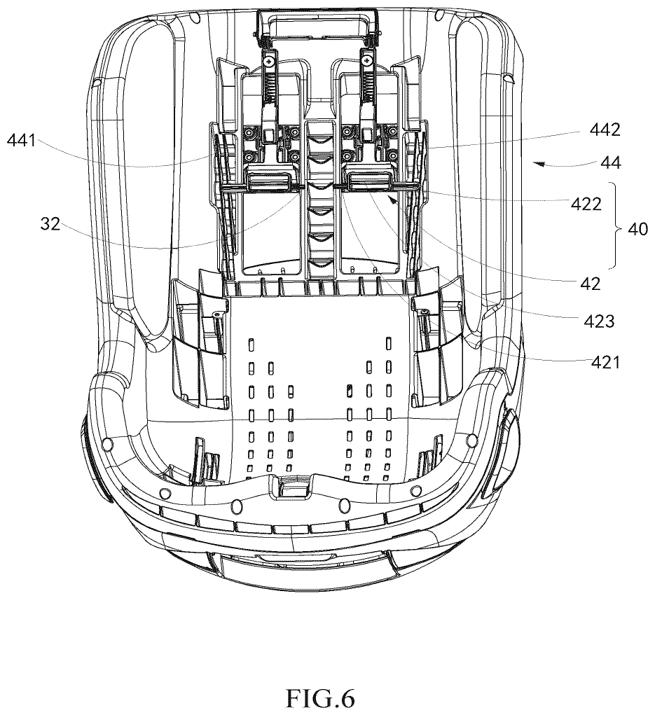

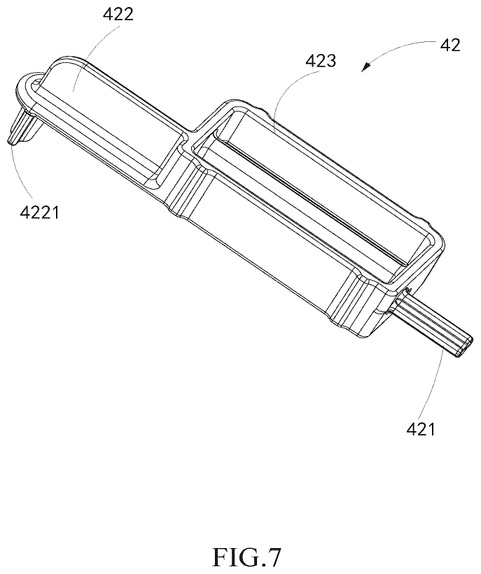

Now the specific structure of the shoulder strap width adjustment mechanism 40 according to the disclosure will be described in detail with reference to FIGS. 5-7, wherein FIGS. 5 and 6 are respectively different structural schematic views of the shoulder strap width adjustment mechanism according to the disclosure, and FIG. 7 is a schematic view of the shoulder strap fixing member according to the disclosure. The shoulder strap width adjustment mechanism 40 mainly includes a rail device 44 and two shoulder strap fixing members 42, and the rail device 44 further includes a first rail 441 and a second rail 442 respectively arranged on both sides of the seat backrest 22 in a lateral direction. Preferably, the first rail 441 and the second rail 442 are symmetrically distributed about the longitudinal center line of the seat backrest 22. Moreover, the lateral distance between the first rail 441 and the second rail 442 gradually increases in a direction away from the seat bottom 24.

An example of the specific structure of the shoulder strap fixing members 42 is shown in FIG. 7, and referring to FIGS. 6 and 7 at the same time, each of the shoulder strap fixing members 42 includes a first end 421 and a second end 422 opposite to each other, and a shoulder strap accommodating part 423 is positioned between the first end 421 and the second end 422. The shoulder strap of the child safety seat 1 is fixedly connected to the shoulder strap accommodating part 423. The first end 421 is laterally inserted into an aperture 32 of the headrest 30, and a length of the first end 421 inserted into the aperture 32 is changed as the shoulder strap fixing member 42 sliding up and down in the longitudinal direction. For example, in the process that the shoulder strap fixing member 42 slides away from the seat bottom 24 in the longitudinal direction, the length of the first end 421 inserted into the aperture 32 gradually reduces; on the contrary, in the process that the shoulder strap fixing member 42 slides close to the seat bottom 24 in the longitudinal direction, the length of the first end 421 inserted into the aperture 32 gradually increases. The second end 422 of the shoulder strap fixing member 42 is longitudinally slidably connected to corresponding rails. For example, in FIG. 6, the second end 422 of the shoulder strap fixing member 42 arranged on the left side of the seat backrest 22 is slidably arranged on the first rail 441, and the second end 422 of the shoulder strap fixing member 42 arranged on the right side of the seat backrest 22 is slidably arranged on the second rail 442. Furthermore, the two first ends 421 of two shoulder strap fixing members 42 on the left and right sides are inserted into the two apertures 32 of the headrest 30, so that in the process for the headrest 30 sliding up and down in the longitudinal direction, the shoulder strap fixing members 42 can slide with the headrest 30 because the first ends are inserted into the apertures 32 of the headrest 30; and the second ends 422 of the shoulder strap fixing members 42 slides along the first rail 441 and the second rail 442. Since the lateral distance between the first rail 441 and the second rail 442 gradually increases in the direction away from the seat bottom 24, the lateral distance between the two shoulder strap fixing members 42 also gradually increases in the direction away from the seat bottom 24, and gradually decreases in the direction close to the seat bottom 24.

As another embodiment of the shoulder strap fixing members 42, the shoulder strap fixing members 42 each has a retractable structure, such that, the lateral lengths of the shoulder strap fixing members 42 continuously increases in a process of sliding upward, and in a process of sliding downward, for example, the lateral lengths of the shoulder strap fixing members continuously reduce. For example, each of the shoulder strap fixing members 42 in this embodiment includes a shoulder strap accommodating part 423 for fixing the shoulder strap, and a first member and a second member telescopically connected to each other. The first member is laterally and slidably inserted into inserted into the corresponding aperture 32 of the seat headrest, the second member is longitudinally and slidably connected to a corresponding rail, and the shoulder strap accommodating part 423 is fixed on the second member. As a result, as the shoulder strap fixing members 42 slide up and down in the longitudinal direction, a relative telescopic movement is performed between the first members and the second members, so the lateral distance between the two shoulder strap fixing members 42 gradually changes with their movement in the longitudinal direction.

According to an embodiment of the disclosure, for example, both the first rail 441 and the second rail 442 are in the shape of a long groove, and each of the long groove-shaped rails has a constant cross-sectional shape. Accordingly, the second end 422 of each of the shoulder strap fixing members 42 is provided with a slider 4221, and the slider 4221 cooperates with the long groove for sliding.

According to another embodiment of the disclosure, for example, the first rail 441 and the second rail 442 each is in a shape of a rod, and each of the rails in a shape of a rod has a constant cross-sectional shape. Accordingly, each of the second ends 422 of the shoulder strap fixing members 42 includes a sliding groove part which cooperates with the rod to slide.

According to the shoulder strap width adjustment mechanism 40 and the child safety seat 1 including shoulder strap width adjustment mechanism 40 of the disclosure, the height of the headrest 30 is adjustable and at the same time the shoulder strap width is adjustable simultaneously, thereby satisfying the requirements for the shoulder strap width of the children of different ages and different body types, and greatly improving the comfortability and safety of the child safety seat 1.

According to the shoulder strap width adjustment mechanism and the child safety seat including the shoulder strap width adjustment mechanism of the disclosure, the shoulder strap width can be adjusted synchronously during the process of adjusting the height of the headrest, so as to meet the requirements of children of different heights and different body types.

In an embodiment, each of the shoulder strap fixing members includes: a first end, a second end, and a shoulder strap accommodating part positioned between the first end and the second end, the first end is laterally and slidably inserted into a corresponding aperture of the seat headrest, and the second end is longitudinally and slidably connected to a corresponding rail.

Each of the first rail and the second rail is in a shape of a long groove and has a constant cross-sectional shape; and the second end of each of the shoulder strap fixing members is provided with a slider, and the slider cooperates with the long groove.

Each of the first rail and the second rail is in a shape of a rod and has a constant cross-sectional shape; accordingly, the second end of each of the shoulder strap fixing members is provided with sliding groove part, and the sliding groove part cooperates with the rod.

Each of the shoulder strap fixing members includes: a shoulder strap accommodating part, and a first member and a second member telescopically connected to each other, the first member is laterally and slidably inserted into a corresponding aperture of the seat headrest, the second member is longitudinally and slidably connected to a corresponding rail, and the shoulder strap accommodating part is fixed on the second member.

In an embodiment, the first rail and the second rail are symmetrically arranged in respect to a longitudinal center line of the seat backrest.

In an embodiment, the lateral distance between the two shoulder strap holes increases as a distance between the seat headrest and the seat bottom increases, and decreases as the distance between the seat headrest and the seat bottom decreases.

The child safety seat of the disclosure further comprises a clamping bar for locating the seat headrest to the seat shell.

The description provided herein illustrates the various features by preferred and exemplary embodiments. Those ordinary skilled in the art can make many other embodiments, modifications and variations within the scope and spirit of the appended claims by reading this specification.

Reference Numeral List:

| | | |
|---|---|---|
| 1: Child Safety Seat | | |
| 10: Base | | |
| 20: Seat Shell | | |
| 22 Seat Backrest | 220 Shoulder | |
| | Strap Hole | |
| 24 Seat Bottom | | |
| 30: Seat Headrest | | |
| 32 aperture | | |
| 40: Shoulder Strap Width | | |
| Adjustment Mechanism | | |
| 44 Rail Device | | |
| 441 First Rail | 442 Second Rail | |
| 42 Shoulder Strap | | |
| Fixing Member | | |
| 421 First End | 422 Second End | 423 Shoulder Strap |
| | | Accommodating Part |
| 4221 Slider | | |
| 50: Clamping Bar | | |

1. A shoulder strap width adjustment mechanism for use with a child seat, the shoulder strap width adjustment mechanism comprising:
a rail device including a first rail and a second rail, the rail device being positionable at a backrest of a seat such that a lateral distance between the first rail and the second rail being gradually changed in a longitudinal direction; and
two shoulder strap fixing members coupled to a headrest of the child seat and slidable with the headrest relative to the rail device, each of the two shoulder strap fixing members being translatable relative to the headrest as the headrest slides relative to the rail device.

2. The shoulder strap width adjustment mechanism of claim 1, wherein each of the two shoulder strap fixing members has a first end slidably arranged within at least one aperture formed in the headrest.

3. The shoulder strap width adjustment mechanism of claim 2, wherein a length of the first end of each of the two shoulder strap fixing members arranged within the at least one aperture varies as the headrest slides relative to the rail device.

4. The shoulder strap width adjustment mechanism of claim 3, wherein the length of the first end of each of the two shoulder strap fixing members arranged within the at least one aperture decreases as the headrest slides relative to the rail device toward a top of the backrest.

5. The shoulder strap width adjustment mechanism of claim 1, wherein each shoulder strap fixing member includes a shoulder strap accommodating part for receiving a shoulder strap of a safety belt.

6. The shoulder strap width adjustment mechanism of claim 1, wherein a lateral length of each shoulder strap fixing member is fixed.

7. The shoulder strap width adjustment mechanism of claim 1, wherein the first rail and the second rail are arranged symmetrically relative to a longitudinal center line of the backrest.

8. The shoulder strap width adjustment mechanism of claim 1, wherein each of the first rail and the second rail is a rod having a constant cross-sectional shape and a second end of each shoulder strap fixing member includes a slider, the slider being engaged with the rod.

9. The shoulder strap width adjustment mechanism of claim 1, wherein each of the first rail and the second rail includes an elongated groove having a constant cross-sectional shape and a second end of each shoulder strap fixing member includes a slider, the slider being engaged with the groove.

10. A child seat for a vehicle comprising:
a seat shell including a backrest and a bottom;
a headrest slidably connected to the backrest; and
a shoulder strap width adjustment mechanism arranged at the backrest and having two shoulder strap accommodating parts, the shoulder strap width adjustment mechanism being movably engaged with the headrest such that a lateral distance between the two shoulder strap accommodating parts changes as the headrest slides relative to the backrest.

11. The child seat of claim 10, wherein the headrest is movable along a longitudinal axis of the backrest and the two shoulder strap accommodating parts are movable with the headrest along the longitudinal axis of the backrest.

12. The child seat of claim 10, wherein the lateral distance between the two shoulder strap accommodating parts increases as a distance between the bottom and the headrest increases.

13. The child seat of claim 10, wherein the two shoulder strap accommodating parts are translatable relative to the headrest.

14. The child seat of claim 10, wherein the headrest includes at least one aperture and the shoulder strap width adjustment mechanism includes two shoulder strap fixing members, the two shoulder strap accommodating parts being part the two shoulder strap fixing members, respectively, wherein each of the two shoulder strap fixing members has a first end slidably arranged within the at least one aperture formed in the headrest.

15. The shoulder strap width adjustment mechanism of claim 14, wherein a length of the first end of each of the two shoulder strap fixing members arranged within the at least one aperture varies as the headrest slides relative to the backrest.

16. The shoulder strap width adjustment mechanism of claim 15, wherein the length of the first end of each of the two shoulder strap fixing members arranged within the at least one aperture decreases as the headrest slides toward a top of the backrest.

17. The shoulder strap width adjustment mechanism of claim 10, further comprising a first rail and a second rail arranged at the backrest, the two shoulder strap accommodating parts being movably coupled to one of the first rail and the second rail, respectively.

18. The shoulder strap width adjustment mechanism of claim 17, wherein a lateral spacing between each of the two shoulder strap accommodating parts and a respective one of the first rail and the second rail is fixed over a length relative to the first rail and the second rail as the headrest slides relative to the backrest.

19. The shoulder strap width adjustment mechanism of claim 17, wherein the first rail and the second rail are arranged symmetrically relative to a longitudinal center line of the backrest.

20. The shoulder strap width adjustment mechanism of claim 10, further comprising a clamping bar locating the headrest relative to the seat shell.
